(19) United States
(12) Patent Application Publication
(10) Pub. No.: US 2009/0104521 A1
(43) Pub. Date: Apr. 23, 2009

(54) Storage battery and insulating material and battery container using the same

(76) Inventors: Norifumi Yasuda, Saitama (JP); Hisashi Katoh, Saitama (JP); Shigeki Oyama, Saitama (JP); Eisuke Komazawa, Saitama (JP); Yasuhiro Matsumoto, Saitama (JP); Shuji Sasaki, Saitama (JP); Kenichi Murakami, Saitama (JP); Masayuki Ishii, Kanagawa (JP); Hiroshi Fujimoto, Kanagawa (JP); Kanji Kuroda, Kanagawa (JP); Yoshiaki Yui, Kanagawa (JP); Toshinori Moriga, Kanagawa (JP); Munemitsu Hirotsu, Kanagawa (JP)

Correspondence Address: ARENT FOX LLP, 1050 CONNECTICUT AVENUE, N.W., SUITE 400, WASHINGTON, DC, 20036, US

(21) Appl. No.: 11/919,627

(22) PCT Filed: May 17, 2006
(86) PCT No.: PCT/JP2006/309866

§ 371 Date: Oct. 31, 2007

(30) Foreign Application Priority Data
May 17, 2005 (JP) 2005-144413
May 17, 2005 (JP) 2005-144427
May 17, 2005 (JP) 2005-144725
May 17, 2005 (JP) 2005-144741

(51) Int. Cl. H01M 2/06; H01M 2/08; H01M 2/04; C08G 63/127

(52) U.S. Cl. 429/174; 429/175; 264/259; 528/308.1

(57) ABSTRACT

A storage battery which can further intensify the sealing properties of the electrode rod piercing portion thereof, a technique capable of increasing the area of the sealing surface at the sealed portion of the storage battery, a technique capable of certainly preventing the missing of mounting of a rubber-based sealing material corresponding to O-ring at the sealed portion of the storage battery, and an insulating material having an excellent corrosion resistance to highly corrosive battery content and a battery container including same are provided.

An electrode rod 14 is allowed to extend upward through an annular member 15, a pressing member 18 is placed on the annular member 15, and a nut 22 is then threaded on a thread portion 21. This threading job is effected until the pressing member 18 is placed on and stopped by a collar portion 23. At the time when threading ends, a neck portion 25 is somewhat compressed to exhibit sealing properties. At the same time, a head portion 26 is drastically compressed and thus forms a first sealing portion at Point P1, a second sealing portion at Point P2 and a third sealing portion at Point P3. Further, while a disc sealing member 23 being properly compressed by the annular member 15 made of a resin and a current collecting plate 17, they are put in a vacuum heating furnace where they are then subjected to heat treatment at 160° C. in vacuo for 72 hours. This heat treatment allows PET film 25 to be heat-fused to the annular member 15 made of a resin and PET film 26 to be heat-fused to the current collecting plate 17. Moreover, a lid body 12 is formed integrally with an annular member 15 of rubber having a spindle-shaped section. And, this annular member 15 of rubber is bonded to PET film 32, 32 by the action of adhesive layer 33, 33. Since this bonding is firm, the annular member 15 of rubber cannot be detached from the lid body 12 during use.

Further, an insulating material for electrode mounting to be used in a battery container which is made of a polyethylene terephthalate resin and a container having a lid member obtained by forming a polyester resin-coated aluminum sheet double-seamed attached to the opening of the body of a can are provided, and a polyethylene terephthalate resin insulating material for electrode mounting is attached to a through-hole provided piercing the central part of the lid member with an adhesive including (B) a hardener made of at least one of phenolic resin, amino resin and polyisocyanate resin incorporated in (A) a polyester resin including a dicarboxylic acid component mainly including terephthalic acid and a glycol component and having a glass transition temperature of from 30° C. to 110° C., whereby the battery content has an excellent corrosion resistance to the electrolyte including a highly corrosive propylene carbonate salt as a main component, etc. and an enhanced leakage resistance.

### TECHNICAL FIELD

The present invention relates to a technique for intensifying the sealing properties of the electrode rod through-hole of a storage battery.

The present invention also relates to an insulating material excellent in resistance to corrosion with electrolyte and a battery container including same and more particularly to an insulating material made of a polyethylene terephthalate resin and a battery container having the insulating material attached to a lid member obtained by forming a polyester resin-coated aluminum sheet.

### BACKGROUND ART

With the electrification/electronization of automobile devices, the use of chargeable products such as secondary battery, electrolytic capacitor and capacitor (referred to as “storage battery”) has increased.

A storage battery has an electricity-storing element received in a sealed case from which electricity-storing element is withdrawn electric energy through an electrode and thus needs to have the electrode extend protruding through the lid body of the sealed case.

The seal between the lid body and the electrode is important and various seal structures are proposed (see, e.g., Patent Reference 1).

Patent Reference 1: JP-A-2000-150324 (FIG. 3)

FIG. 10 is a diagram illustrating the basic configuration of a conventional technique and this storage battery 100 has an aluminum lid body 102 fixed to an end of an aluminum cylinder 101 by caulking and an aluminum terminal 104 fixed to the lid body 102 with a sealing member 103 made of resin interposed therebetween.

Resins include soft resins and hard resins, and the sealing member 103 made of resin is a structural part and thus is made of a hard resin. A hard resin has a great strength but has a poor elasticity.

By the way, when a harness 105 shown by an imaginary line is attached to the terminal 104 with a bolt 106, external force is inevitably applied in the horizontal direction and vertical direction as viewed on the drawing.

In addition, aluminum and resin differ from each other in physical properties such as heat expansion and thus form a fine gap when used over an extended period of time. Due to external force, this fine gap grows to a great crack that causes the leakage of the electrolyte packed in the cylinder or other defects.

Further, in recent years, for the purpose of enhancing the performance of storage battery or compacting storage battery, a structure including a current collecting plate attached directly to the electrode 104 has been proposed. In this case, the current collecting plate, too, becomes an external force source and thus forms a fine gap between the resin and the metal and then causes this gap to grow to a great crack. When such a crack is generated, the storage battery needs to be replaced, reducing the lifetime of the storage battery.

In order to prolong the lifetime of the storage battery, it is necessary that the sealing properties of the electrode rod piercing portion of the storage battery be further enhanced.

To this end, a structure including an O-ring provided interposed between the sealing member 103 made of resin and the aluminum lid body 102 or between the sealing member 103 made of resin and the aluminum terminal 104 as a rubber-based sealing member is proposed (see, e.g., Patent Reference 2).

Patent Reference 2: JP-A-8-69783 (FIG. 14)

FIG. 14 is a configurational diagram of a conventional technique using an O-ring and a metallic lid 111 has a concave 112 formed thereon, a small diameter concave 113 formed at the bottom of this concave 112 and a through-hole 114 formed communicated to this small diameter concave 113. And, the electrode rod 115 is disposed extending through the through-hole 114, an O-ring 116 is fitted on this electrode rod 115 and this O-ring 116 is also fitted in the small diameter concave 113. To the upper part of the electrode rod 115 is connected a terminal 118, and the concave 112 is then filled with a resin encapsulant 117 to fix the electrode rod 115, and this is a basic structure.

Even when a fine gap is formed between the metallic lid 111 and the resin encapsulant 117 or between the metallic electrode rod 115 and the resin encapsulant 117 with time, the sealing action of the O-ring 116 makes it possible to prevent liquid leakage.

In principle, the O-ring 116 is a wire or very thin band extending around the peripheral surface of the electrode rod 115 and forms a seal wire or seal surface. When any flaw exists or is generated on the electrode rod 115 or O-ring 116, liquid leakage occurs through this flaw. This flaw can be generated due to working or assembly or with time.

It is practically desirable that the area of the seal surface be increased, making the electrode rod 115 or O-ring 115 little subject to the effect of flaw.

Further, the O-ring 116 is a separate part and it is thus likely that the mounting of the O-ring 116 can be missed. Even when the mounting of the O-ring 116 is missed, the resin encapsulant 117 exhibits sealing properties for the time being, retarding the realization of the fact that the mounting of the O-ring 116 is missed. Therefore, this proposal has something to be desired.

Then, a technique capable of preventing the missing of mounting of O-ring is desired.

Further, as disclosed in Patent Reference 3 and Patent Reference 4, a battery container for use in battery, electrolytic capacitor, etc. is obtained by blank-stamping a metallic sheet such as aluminum sheet into a disc which is then deep-drawn or otherwise worked to form a can body to the upper opening of which a top lid is curled sealed. And, in order to draw the electrode out of the battery container, an insulating material made of an electrically insulating synthetic resin or the like is provided.

As such an insulating material, those obtained by forming an urethane rubber or polypropylene resin into a shape following that of the through-hole is often used, and they are attached to a metallic sheet such as aluminum sheet which is a raw material with an adhesive.

Further, the battery container is filled with an electrolyte including as a battery content a highly corrosive propylene carbonate salt as a main component, but the aforementioned insulating material formed by an urethane rubber or polypropylene resin showed an insufficient corrosion resistance to such a highly corrosive content and thus often caused the leakage of liquid content.

Moreover, as a container material having an excellent corrosion resistance, a polyester resin-coated aluminum sheet are used more often.

However, the polyester resin film covering the surface of the lid member to which the insulating material is attached is disadvantageous in that it shows an insufficient adhesivity to the insulating material.

Patent Reference 3: Japanese Patent No. 3427216

Patent Reference 4: JP-A-2002-343310

### DISCLOSURE OF THE INVENTION

### Problems to be Solved by the Invention

The present invention has an object of providing a storage battery which can further intensify the sealing properties of the electrode rod piercing portion of the storage battery.

Further, the present invention has an object of providing a technique capable of increasing the area of sealing surface in the sealing portion of the storage battery.

Moreover, the present invention has an object of providing a technique capable of certainly preventing the mounting of a rubber-based sealing member corresponding to O-ring to the sealing portion of the storage battery from being missed.

Further, the present invention is worked out in the light of the aforementioned problems and has an object of providing an insulating material having an excellent corrosion resistance to highly-corrosive battery contents.

Moreover, the present invention has an object of providing a battery container having an insulating material firmly attached to a lid member with an adhesive excellent in adhesivity to the insulating material even in the case where as the container material there is used a polyester resin-coated aluminum sheet.

### Means for Solving the Problems

According to claim 1, there is provided with a storage battery including:

a lid body having a hole formed therein,

an annular member provided surrounding the hole,

a current collecting plate disposed on one side of the lid body,

an electrode rod extending from the current collecting plate and protruding beyond the hole and a pressing plate disposed on the other side of the lid body, so as to interpose the annular member between the pressing plate and the current collecting plate to fix the electrode rod to the lid body, wherein

a collar portion is provided at the base of the electrode rod, the collar portion having a greater diameter than that of the electrode rod and a greater thickness than that of the lid body, and being arranged to receive the pressing plate, and

the annular member is entirely or partially formed by a rubber sheet having a greater thickness than that of the collar portion.

According to claim 2, there is provided with a storage battery including:

a lid body having a hole formed therein,

an annular member provided surrounding the hole,

a current collecting plate disposed on one side of the lid body,

an electrode rod extending from this current collecting plate and protruding beyond the hole, and

a pressing plate disposed on the other side of the lid body, so as to interpose the annular member between the pressing plate and the current collecting plate to fix the electrode rod to the lid body, wherein

the annular member is formed by a resin sheet of which forward end has a slant provided thereon for pressing against an O-ring or liquid packing set at the base of the electrode rod.

According to claim 3, there is provided with a storage battery including:

an electricity-storing element and a current collecting plate received in a cylinder body, an opening of the cylinder body being closed by a lid body having an electrode rod through-hole of which edge is surrounded by an annular member made of a resin, and

a disc sealing member provided interposed between the current collecting plate and the annular member made of a resin, wherein

the lid body and the current collecting plate are disposed parallel to each other to keep the electrode piercing portion airtight,

the disc sealing member has a three-layer structure having a PET film laminated on the upper and lower sides of a rubber sheet, and

one of the two PET films is arranged to be heat-fused to the metallic current collecting plate, and the other is arranged to be heat-fused to the annular member made of a resin to exert an airtighting effect.

According to claim 4, there is provided with a method for manufacturing a lid body for storage battery including:

a resin-coated metallic sheet having a PET film laminated on a metallic sheet, and

an annular member made of a rubber integrally attached thereto surrounding a hole provided therein, the annular member made of a rubber keeping the airtightness of an electrode rod piercing portion,

the method including:

a step of forming a hole in the resin-coated metallic sheet,

a step of spreading an imide-based adhesive over the PET film surrounding the hole and drying the adhesive to form an adhesive layer,

a step of setting the resin-coated metallic sheet including an adhesive layer into a forming mold,

a step of extruding a rubber-based melt material into the forming mold to form an annular member made of a rubber, and

a step of removing the forming mold to obtain a lid body.

According to claim 5, there is provided with an insulating material for electrode mounting to be used in a battery container, which is made of a polyethylene terephthalate resin.

According to claim 6, there is provided with a battery container including:

a lid member obtained by forming a polyester resin-coated aluminum sheet attached double-seamed to an opening of a body of a can, and

a polyethylene terephthalate resin insulating material for electrode mounting, the polyethylene terephthalate resin insulating material being attached to a through-hole provided by piercing a central part of the lid member with an adhesive, wherein

the adhesive is obtained by incorporating a hardener (B) incorporated in a resin (A) as follows:

(A) a polyester resin including a dicarboxylic acid component mainly including terephthalic acid and a glycol component, and having a glass transition temperature of from 30° C. to 110° C.;

(B) a hardener made of at least one of phenolic resin, amino resin and polyisocyanate resin.

According to claim 7, there is provided with a battery container including:

a lid member obtained by forming a polyester resin-coated aluminum sheet, the lid member attached double-seamed to an opening of a body of a can, and

a polyethylene terephthalate resin insulating material for electrode mounting, the polyethylene terephthalate resin insulating material being attached to a through-hole provided by piercing a central part of the lid member with an adhesive, wherein

the adhesive is obtained by incorporating a hardener (B) in a resin (A) as follows:

(A) a polyester resin including a dicarboxylic acid component having a terephthalic acid content of from 80 to 100 mol-% and a glycol component, having a glass transition temperature of from 30° C. to 110° C. and having a number-average molecular weight of from 8,000 to 30,000;

(B) a hardener made of a polyisocyanate resin.

According to claim 8, there is provided with the battery container as described in claim 6 or 7, wherein

the adhesive has a (A):(B) weight ratio of from 90:10 to 99:1.

### EFFECTS OF THE INVENTION

In the invention according to Claim 1, the annular member is formed by a rubber sheet. The rubber sheet is rich in elasticity and exhibits sealing properties and thus can maintain the sealing properties of the electrode rod piercing portion over an extended period of time, making it possible to prolong the lifetime of the storage battery.

The movement of the pressing member is restricted by a collar portion so that the rubber sheet cannot be excessively compressed.

In the invention according to Claim 2, the annular member is formed by a resin sheet the forward end of which has a slant provided thereon for pressing against an O-ring or liquid packing set at the base of the electrode rod.

The resin sheet is poor in elasticity and thus cannot be expected to have sealing properties. However, since the slant provided on the forward end of the resin sheet presses against the O-ring or liquid packing, this slant and the O-ring or liquid packing can together maintain the sealing properties of the electrode rod piercing portion over an extended period of time, making it possible to prolong the lifetime of the storage battery.

In the invention according to Claim 3, a disc sealing member is interposed between the annular member made of a resin on the lid body side and the underlying current collecting plate. The disc sealing member has a large area and thus can drastically increase the area of the sealing surface as compared with O-ring.

The displacement of the electrode rod in the axial direction can be sufficiently followed because the thickness of the rubber sheet varies elastically. The displacement of the electrode rod in the direction perpendicular to the axis thereof can be followed by the shear deformation of the rubber sheet.

Methods for bonding a rubber material to a metal or resin are known. However, there are some cases where the adhesive components used in these methods undergo dissolution in or elution with the organic solvent incorporated in the electrolyte, causing the leakage of the electrolyte or the deterioration of capacitor properties. The present invention can exert an effect of eliminating these defects.

In the invention according to Claim 4, an imide-based adhesive is employed. This imide-based adhesive exhibits a high adhesive strength with respect to PET film and annular member made of rubber. As a result, the annular member made of rubber can be firmly bonded to PET film.

Since an annular member made of rubber corresponding to O-ring can be integrally attached to the lid body, it is not necessary to concern if the annular member made of rubber may not be mounted or may be lost.

In the invention according to Claims 5 to 8, the insulating material is made of a polyethylene terephthalate resin and thus exhibits, as a battery content, an excellent corrosion resistance with an electrolyte mainly including as a main component a highly corrosive propylene carbonate salt, making it possible to enhance the resistance to leakage of contents.

The battery container of the present invention includes an insulating material made of a polyethylene terephthalate resin and has the insulating material bonded to the lid member made of a polyester resin-coated aluminum sheet with an adhesive having a specific formulation, making it possible to firmly bond the insulating material to the through-hole in the lid member and hence give an excellent resistance to leakage of battery contents.

### BRIEF DESCRIPTION OF THE DRAWINGS

FIG. 1 is a perspective view of a storage battery according to the present invention.

FIG. 2 is a sectional view of an essential part of the storage battery according to the present invention.

FIG. 3 is an exploded view of an essential part of the storage battery according to the present invention.

FIG. 4 is a diagram illustrating the action of FIG. 3.

FIG. 5 is a diagram illustrating another embodiment of FIG. 3.

FIG. 6 is a diagram illustrating the action of FIG. 5.

FIG. 7 is a diagram illustrating further embodiment of FIG. 3.

FIG. 8 is a diagram illustrating the action of FIG. 7.

FIG. 9 is a plan view of the lid body of the storage battery according to the present invention.

FIG. 10 is a diagram illustrating a basic configuration of a conventional technique.

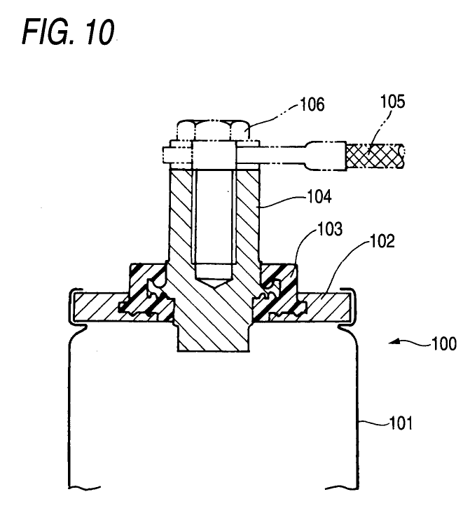

FIG. 11 is a sectional view of an essential part of the storage battery according to the present invention.

FIG. 12 is an exploded view of an essential part of the storage battery according to the present invention.

FIG. 13 is a diagram illustrating the action of FIG. 11.

FIG. 14 is a configurational diagram of a conventional technique using an O-ring.

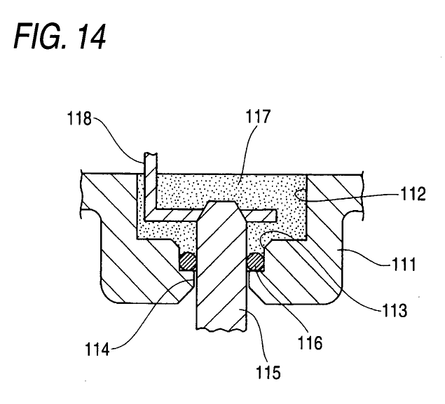

FIG. 15 is a sectional view of a resin-coated metallic sheet for use in the present invention.

FIG. 16 is a sectional view of a sample according to the present invention.

FIG. 17 is a diagram illustrating the principle of measurement of peeling strength.

FIG. 18 is a graph of the results of measurement.

FIG. 19 is a flow chart of manufacturing a lid body according to the present invention.

FIG. 20 is a sectional view of an essential part of a completed lid body.

FIG. 21 is a perspective view illustrating an exploded configurational diagram of a battery container of the present invention.

FIG. 22(a) is a plan view of an insulating material of the present invention and FIG. 22(b) is a sectional view taken on A-A line of FIG. 22(a).

### DESCRIPTION OF REFERENCE NUMERALS AND SIGNS

10 Storage battery
11 Cylinder
12 Lid body
14 Electrode rod
15 Annular member
16 Hole
17 Current collecting plate
18 Pressing plate
19 Electricity-storing element
23 Collar portion
26 Head portion
27 O-ring
28 Slant provided on annular member
29 Paint
d Diameter of electrode rod
T Thickness of collar portion
131 (37) Through-hole
223 Disc sealing member
224 Rubber sheet
225, 226 PET film
30 Resin-coated metallic sheet
31 Metallic sheet
32 PET film
33 Adhesive layer
34 Forming mold
35 Injection cylinder
1 Lid member
2 Body of can
2f Flange
4 Through-hole
4a Ring
4b Bore portion
4c Annular concave
5a Electrode
5b Electrode

### BEST MODE FOR CARRYING OUT THE INVENTION

The best mode for carrying out the present invention will be described in connection with the attached drawings. The storage battery can be applied to both cylindrical storage battery and rectangular storage battery, but the following examples will be described with reference to rectangular storage battery.

### Example 1

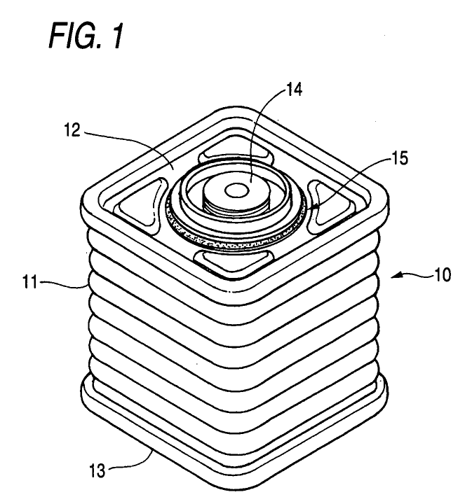

FIG. 1 is a perspective view of a storage battery according to the present invention and a storage battery 10 is a sealed case including a corrugated (wavy) cylinder 11 the upper opening of which is closed by a lid body 12 and the lower opening of which is closed by a bottom lid 13. The bottom lid 13 may be formed by deep drawing at the same time with the cylinder 11. The reference numeral 14 indicates an electrode rod and the reference numeral 15 indicates an annular member.

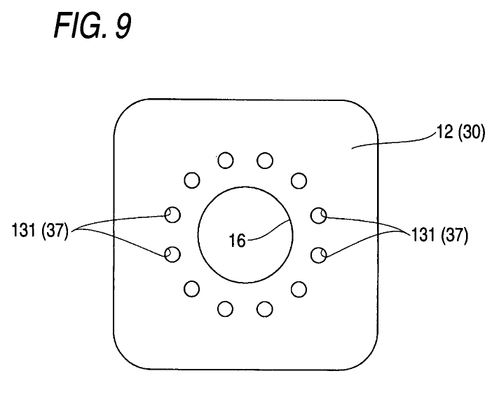

Explaining the lid body 12 (30) in FIG. 9, the lid body 12 (30) has a hole 16 formed therein at the center thereof and a plurality of through-holes 131 (37) formed therein surrounding this hole 16. These through-holes 131 (37) are formed to enhance the fixability of the annular member 15.

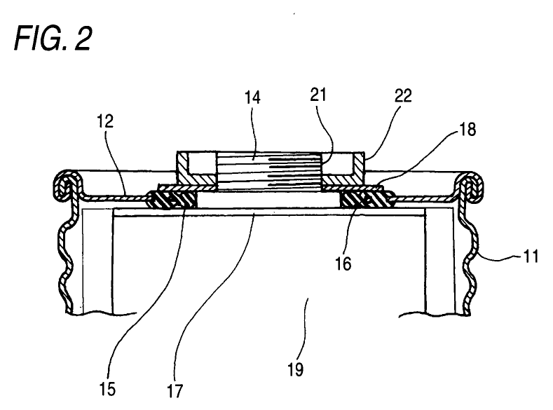

FIG. 2 is a sectional view of an essential part of the storage battery according to the present invention and depicts a structure including a lid body 12 having a hole 16 formed therein, an annular member 15 provided surrounding this hole 16, a current collecting plate 17 disposed on one side (lower side as viewed on the drawing) of the lid body 12, an electrode rod 14 extending from this current collecting plate 17 and protruding beyond the hole 16 and a pressing plate 18 disposed on the other side (upper side as viewed on the drawing) of the lid body 12, whereby the annular member 51 is interposed between this pressing plate 18 and the current collecting plate 17 to fix the electrode rod 14 to the lid body 12.

The pressing plate 18 is a metallic sheet corresponding to washer and a nut 22 is threaded onto a thread 21 provided in the electrode rod 14 to press against the annular member 15.

Further, the current collecting plate 17 is a metallic sheet which acts to collect electric energy stored in the electricity-storing element 19.

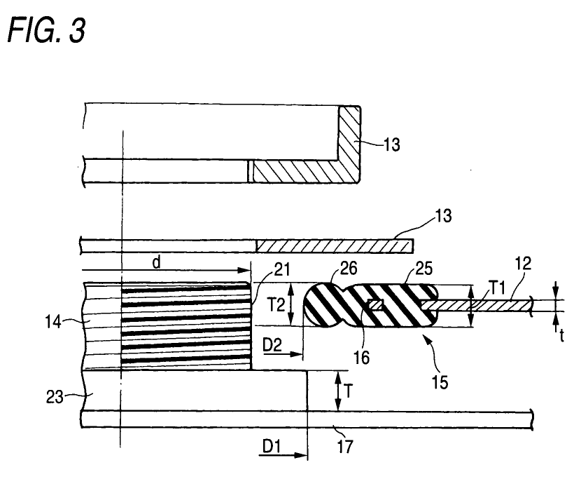

FIG. 3 is an exploded view of an essential part of the storage battery according to the present invention and the electrode rod 14 has a collar portion 23 provided at the base thereof having a greater diameter than the diameter d of the electrode rod 14 and a thickness T which is greater than the thickness t of the lid body 12, which collar portion 23 being arranged to receive the pressing plate 18.

Further, the annular member 15 has a so-called spindle-shaped section including a neck portion 25 having a somewhat greater thickness than the thickness T of the collar portion 23 and a head portion 26 having a sufficiently greater thickness than the thickness T of the collar portion 23 and is formed by a rubber rich in elasticity.

Herein, supposing that the thickness of the collar portion 23 is T, the thickness of the neck portion 25 is T1 and the thickness of the head portion 26 is T2, the relationship T<T1<T2 can be established.

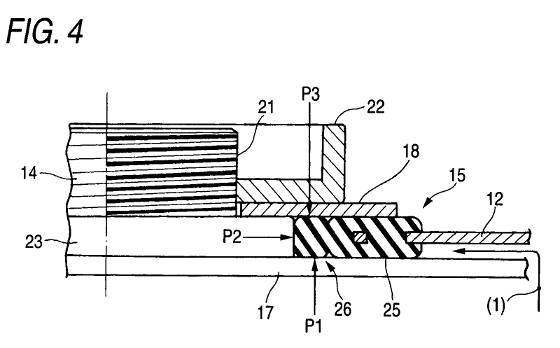

FIG. 4 is a diagram illustrating the action of FIG. 3, the electrode rod 14 extends downward from the annular member 15, the pressing member 18 is placed thereon, and the nut 22 is threaded onto the thread portion 21. This threading job is effected until the pressing member 18 is placed on and stopped by the collar portion 23. At the time when threading ends, the neck portion 25 is somewhat compressed to exhibit sealing properties. At the same time, the head portion 26 is drastically compressed and thus forms a first sealing portion at Point P1, a second sealing portion at Point P2 and a third sealing portion at Point P3.

In other words, as shown in FIG. 3, supposing that the outer diameter of the collar portion 23 is D1 and the inner diameter of the annular member 15 is D2, D1 can be predetermined greater than D2 to compress the head portion 26 in the radial direction, making it possible to form a second sealing portion at Point P2 shown in FIG. 4.

The inner electrolyte or gas reaches the gap between the lid body 12 and the current collecting plate 17 as shown by the arrow (1). Since the annular member 15 is a rubber sheet rich in elasticity, it is not likely that a gap can be formed, making it possible to keep sealing properties.

Even when the sealing properties of the neck portion 25 are deteriorated with time, the sealing properties can be maintained at Points P1 to P3. As a result, the lifetime of the storage battery can be prolonged.

Further, besides including the neck portion 25 and the head portion 26 as in the example, the annular member 15 may have a uniform thickness as a whole or may have a thick portion halfway on the neck portion 25, and the annular member 15 may be a rubber sheet which is entirely or partially thicker than the collar portion 23.

### Example 2

Another embodiment of implementation of the present invention will be described hereinafter.

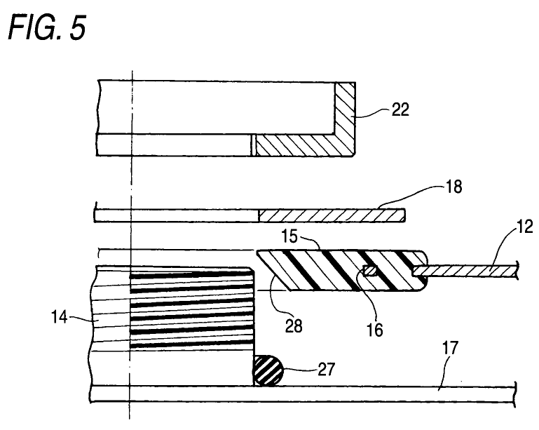

FIG. 5 is a diagram illustrating another embodiment of FIG. 3 and includes a lid body 12 having a hole 16 formed therein, an annular member 15 provided surrounding this hole 16, a current collecting plate 17 disposed on one side (lower side as viewed on the drawing) of the lid body 12, an electrode rod 14 extending from this current collecting plate 17 arranged capable of protruding beyond the hole 16 and a pressing plate 18 disposed on the other side (upper side as viewed on the drawing) of the lid body 12.

And, the annular member 15 is formed by a resin sheet the forward end of which has a slant 28 provided thereon for pressing against an O-ring 27 set at the base of the electrode rod 14.

Further, the resin sheet is a hard resin which has a great strength but a poor stretchability.

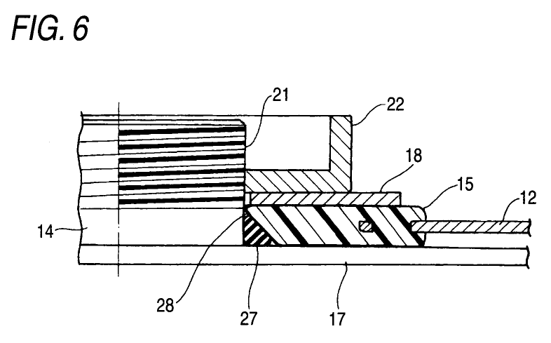

FIG. 6 is a diagram illustrating the action of FIG. 5, the electrode rod 14 extends downward from the annular member 15, the pressing member 18 is placed thereon, and the nut 22 is threaded onto the thread portion 21. This threading job is effected until the pressing member 18 hits and is stopped by the annular member 15.

The O-ring 27 is crushed by the slant 28 and fills the corner portion at which the electrode rod 14 and the current collecting plate 17 cross each other. Even when the annular member 15 makes relative movement rightward as viewed on the drawing with time or otherwise, the O-ring 27 fills the corner portion while returning to the original section. Accordingly, even when the annular member 15 moves somewhat, it is not likely that the sealing properties can be deteriorated.

### Example 3

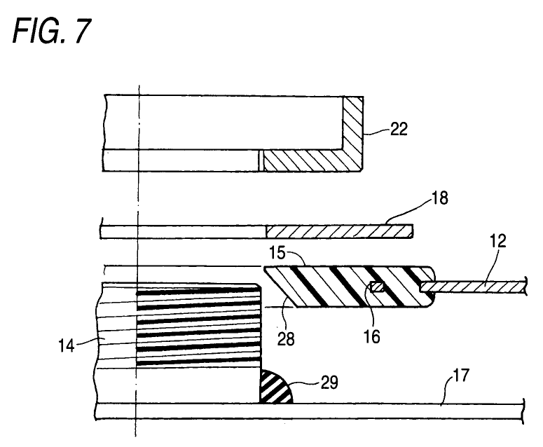

FIG. 7 is a diagram illustrating further embodiment of FIG. 3 and includes a lid body 12 having a hole 16 formed therein, an annular member 15 provided surrounding this hole 16, a current collecting plate 17 disposed on one side (lower side as viewed on the drawing) of the lid body 12, an electrode rod 14 extending from this current collecting plate 17 arranged capable of protruding beyond the hole 16 and a pressing plate disposed on the other side (upper side as viewed on the drawing) of the lid body 12.

And, the annular member 15 is formed by a resin sheet the forward end of which has a slant 28 provided thereon for pressing against a paint 29 made of a composition including PPT-based resin set at the base of the electrode rod 14.

Further, this resin sheet, too, is a hard resin which has a great strength but a poor stretchability as in the previous example.

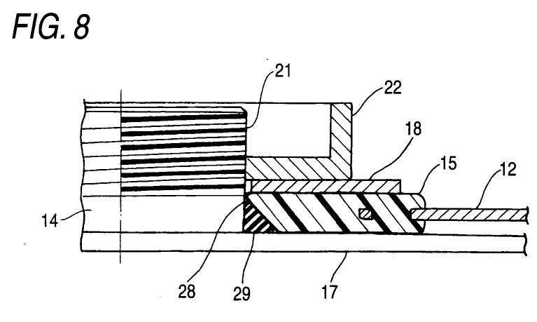

FIG. 8 is a diagram illustrating the action of FIG. 7, the electrode rod 14 extends downward from the annular member 15, the pressing member 18 is placed thereon, and the nut 22 is threaded onto the thread portion 21. This threading job is effected until the pressing member 18 hits and is stopped by the annular member 15.

The paint 29 is crushed by the slant 28 and fills the corner portion at which the electrode rod 14 and the current collecting plate 17 cross each other. Even when the annular member 15 makes relative movement rightward as viewed on the drawing with time or otherwise, the paint 29 fills the corner portion while expanding. Accordingly, even when the annular member 15 moves somewhat, it is not likely that the sealing properties can be deteriorated.

### Example 4

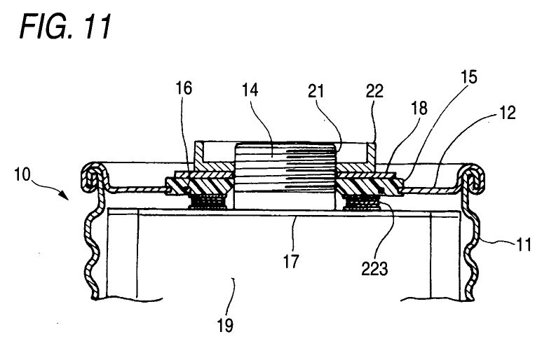

FIG. 11 is a sectional view of an essential part of the storage battery according to the present invention and depicts the upper structure of a storage battery 10 including an electricity-storing element 19 and a current collecting plate received in a cylinder 11, the opening of which cylinder being closed by a lid body 12 having an electrode rod through-hole 16 (hereinafter simply referred to as “hole 16”) the edge of which is surrounded by an annular member 15 made of a resin in such an arrangement that a disc sealing member 223 is provided interposed between the current collecting plate 17 and the annular member 15 made of a resin and the lid body 12 and the current collecting plate 17 are disposed parallel to each other to keep the electrode piercing portion airtight.

Further, the pressing member 18 is a metallic sheet corresponding to washer and a nut 22 is threaded onto a thread 21 provided in the electrode rod 14 to press against the annular member 15.

Moreover, the current collecting plate 17 is a metallic sheet which acts to collect electric energy stored in the electricity-storing element 19.

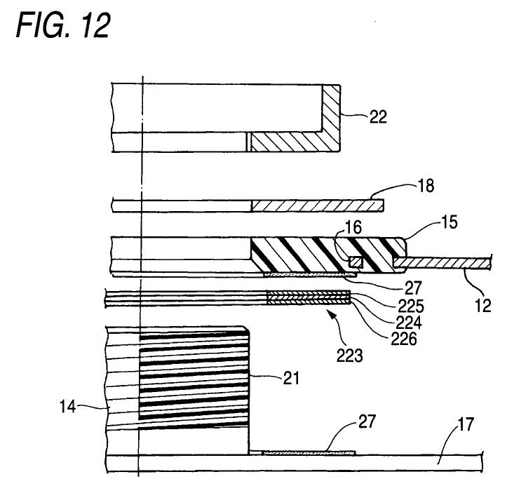

FIG. 12 is a sectional view of an essential part of the storage battery according to the present invention and includes a lid body 12 having a hole 16 formed therein, an annular member 15 made of a resin provided surrounding this hole 16, a current collecting plate 17 disposed on one side (lower side as viewed on the drawing) of the lid body 12, an electrode rod 14 extending from this current collecting plate 17 arranged capable of protruding beyond the hole 16 and a pressing plate 18 disposed on the other side (upper side as viewed on the drawing) of the lid body 12.

And, a disc sealing member 223 is provided interposed between the annular member 15 made of a resin and the current collecting plate 17. This disc sealing member 223 is a three-layer structure obtained by integrally laminating PET film 225 and PET film 226 on the upper and lower sides of a rubber sheet 224, respectively.

The material of the rubber sheet 224 is preferably EPDM (ethylene-propylenediene rubber). And, the thickness of the rubber sheet 224 and PET (polyethylene terephthalate) films 225 and 226 each are from 30 to 100 μm and the thickness of the disc sealing member 223 is from 100 to 200 μm (0.1 to 0.2 mm) as a three-layer structure.

PET film 225 exhibits a good affinity for the annular member 15 made of a resin or the metallic current collecting plate 17 and can provide a high adhesive strength when subjected to heat fusion method.

In the present example, in order to further enhance adhesivity, a PET fusing agent 27, 27 is spread over the lower side of the annular member 15 made of a resin and the upper side of the current collecting plate 17. This PET fusing agent 27, 27 is preferably a composition containing a PPT (polypropylene terephthalate-based) resin.

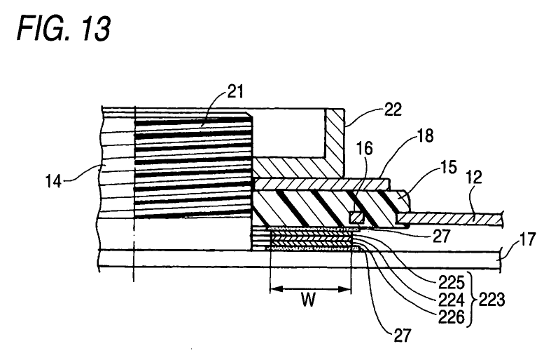

FIG. 13 is a diagram illustrating the action of FIG. 12 and the electrode rod 14 extends downward from the annular member 15, the pressing member 18 is placed thereon, and the nut 22 is threaded onto the thread portion 21.

This threading causes the annular member 15 made of a resin and the current collecting plate 17 to properly compress the disc sealing member 223.

They, in this state, are is put in a vacuum heating furnace where they are then subjected to heat treatment at 160° C. in vacuo for 72 hours.

This heat treatment allows PET film 225 to be heat-fused to the annular member 15 made of a resin and PET film 226 to be heat-fused to the current collecting plate 17. Though shown for convenience, the majority of PET fusing agent 27, 27 is compatible with the annular member 15 made of a resin.

The disc sealing member 223 has a sufficiently great width W and thus can cover flaw, if any on the lower side of the annular member 15 made of a resin or the upper side of the current collecting plate 17, to maintain the sealing properties.

Accordingly, the disc sealing member 223 has a drastically large sealing area as compared with conventional O-ring and thus can maintain the sealing properties over an extended period of time.

The rubber sheet 224 is an elastic member and thus undergoes elastic deformation in the thickness varying direction, i.e., in the axial direction of electrode rod 14 to absorb the displacement of the annular member 15 made of a resin relative to the current collecting plate 17 and the electrode rod 14.

Further, once provided with some thickness, the rubber sheet 224 undergoes elastic deformation in the direction perpendicular to the axis of the electrode rod 14 to absorb the displacement of the annular member 15 made of a resin relative to the current collecting plate 17 and the electrode rod 14.

### Example 5

A method for manufacturing the lid body 12 including the annular member 15 made of rubber having the aforementioned constitution will be described hereinafter.

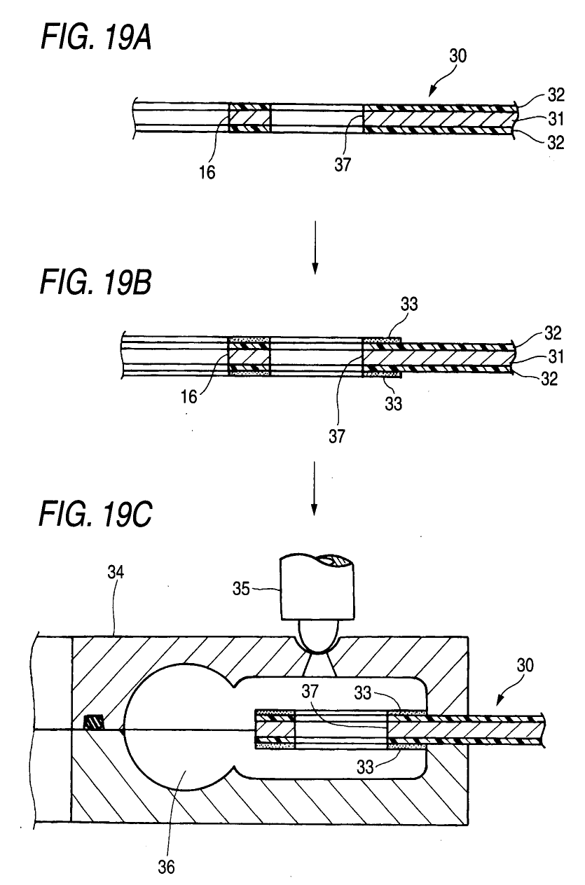

FIG. 19 is a flow chart of manufacturing the lid body according to the present invention.

FIG. 19(a) is a diagrammatic illustrating a process of forming a hole in the resin-coated metallic sheet wherein a resin-coated metallic sheet 30 having PET film 32, 32 having a thickness of from 30 to 100 μm laminated on a metallic sheet 31 such as aluminum is prepared and this resin-coated metallic sheet 30 has a through-hole 37 and a hole 16 for the passage of the electrode rod formed therein.

Explaining again FIG. 19, FIG. 19(b) is a diagram illustrating a process of forming an adhesive layer where an imide-based adhesive is spread over PET film 32, 32 surrounding the hole 16 and then dried at 80° C. for 10 minutes to form an adhesive layer 33, 33.

FIG. 19(c) is a diagram illustrating an injection process where an essential part of the resin-coated metallic sheet 30 including the adhesive layer 33, 33 is set in a forming mold 34. Then, a rubber-based melt material is injected from an injection cylinder 35 into a cavity 36.

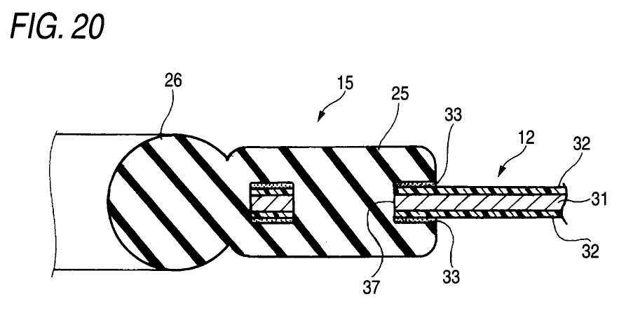

FIG. 20 is a sectional view of an essential part of the completed lid body and shows that the lid body 12 obtained by removing the forming mold is formed integrally with an annular member 15 of rubber having a spindle-shaped section.

Further, this annular member 15 of rubber is firmly bonded to PET film 32, 32 by the action of the adhesive layer 33, 33.

In addition, since the annular member 15 of rubber partly flows into the through-hole 37 where it is then solidified, a mechanical bond can be obtained.

In other words, the annular member 15 of rubber is extremely firmly bonded to the lid body 12 by the adhesive action of the adhesive layer 33, 33 and the mechanical bonding action of the through-hole 37 and thus cannot be detached from the lid body 12 during use.

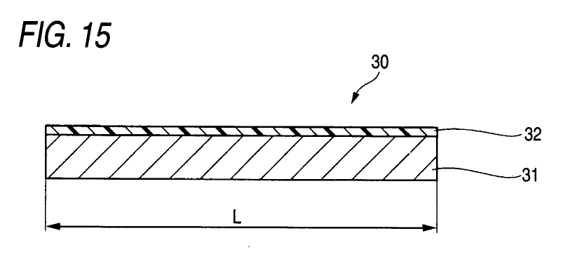

FIGS. 15 to 18, in relation to the aforementioned manufacturing methods of FIGS. 19 and 20, depict experiments on peeling strength in the case where a rubber sheet is bonded to PET film with an imide-based adhesive alone (Example A: same as in FIGS. 19 and 20) and the case where a rubber sheet is bonded to PET film by other methods (Comparative Examples A to C) and its results.

FIG. 15 is a sectional view of a resin-coated metallic sheet and a plurality of sheets of resin-coated metallic sheet 30 having PET (polyethylene terephthalate) film 32 laminated on a metallic sheet 31 are prepared. The metallic sheet 31 is an aluminum sheet (A3004-H12) having a size of 0.5 mm×20 mm×150 mm. Further, the thickness of PET film 32 is 30 μm. In the drawing, L is 150 mm and the dimension of the resin-coated metallic sheet in the direction perpendicular to paper is 20 mm.

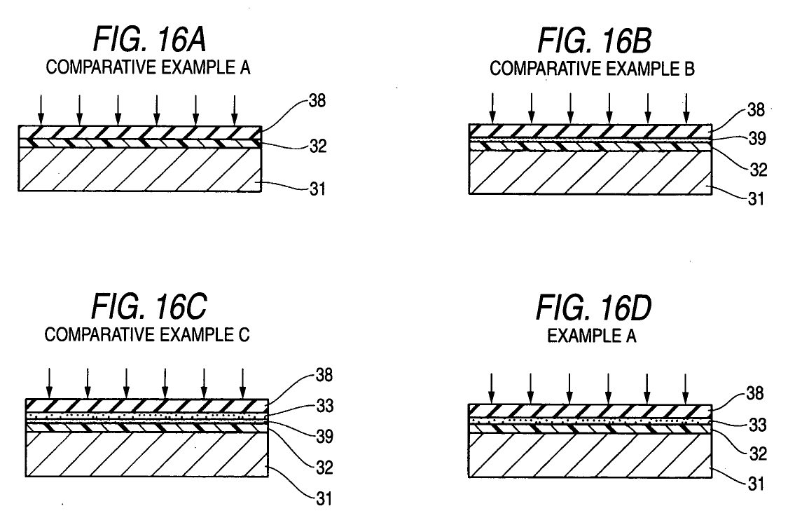

FIG. 16 is a sectional view of a sample according to the present invention. (a): The sample for Comparative Example A is obtained by placing EPDM (ethylene propylenediene rubber) sheet 38 (hereinafter referred to as “rubber sheet 38”) directly on PET film 32, and then contact-bonding the two films at 180° C. for 10 minutes.

(b): The sample for Comparative Example B is obtained by spreading PPT (polypropylene terephthalate-based) resin over PET film 32, and then drying the resin at 110° C. for 10 minutes to form a PPT resin layer 39. This PPT resin is a PET fusing agent which has heretofore been used. Subsequently, a rubber sheet 38 is placed on PPT resin layer 39, and the two layers are then contact-bonded at 180° C. for 10 minutes to obtain the sample.

(c): The sample for Comparative Example C is obtained by spreading PPT resin over PET film 32, and then drying the resin at 110° C. for 10 minutes to form a PPT resin layer 39. Subsequently, an imide-based adhesive (corresponding to CHEMLOK253X, produced by Lord Corporation) is spread over PPT resin layer 39, and the resin is then dried at 80° C. for 10 minutes to form an adhesive layer 33. A rubber sheet 38 is placed on this adhesive layer 33, and the two layers are then contact-bonded at 180° C. for 10 minutes to obtain a sample.

(d): The sample for Example A is obtained by spreading an imide-based adhesive (corresponding to CHEMLOK253X, produced by Lord Corporation) over PET film 32, and then drying the resin at 80° C. for 10 minutes to form an adhesive layer 33. Subsequently, a rubber sheet 38 is placed on the adhesive layer 33, and the two layers are contact-bonded at 180° C. for 10 minutes to obtain the sample.

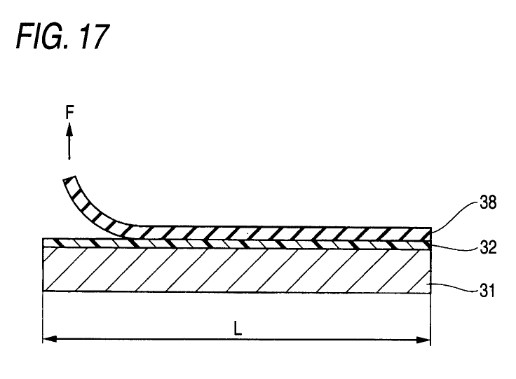

FIG. 17 is a diagram illustrating the principle of measurement of peeling strength and the force F (N) required to peel the rubber sheet 38 from the sample having a width (the size in the back-front direction in the figure) of 20 mm and a length L of 150 mm is defined to be peeling strength. FIG. 17 depicts the sample of FIG. 16(a), but FIGS. 16(b) to 16(d) are similarly measured.

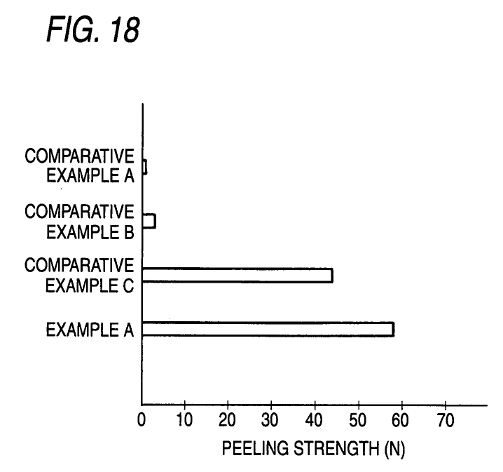

FIG. 18 is a graph of the results of measurement, and in Comparative Example A (see FIG. 16(a)), the peeling strength is 0.1 N and the rubber sheet 38 shown in FIG. 16(a) is little bonded to PET film 32. In Comparative Example B (see FIG. 16(b)), the peeling strength is 3.2 N and exfoliation of the rubber sheet 38 shown in FIG. 16(b) from PPT resin layer 39 shown in FIG. 16(b) is generated.

In Comparative Example C (see FIG. 16(c)), the peeling strength is 44.8 N and partial exfoliation of PPT resin layer 39 shown in FIG. 16(C) from the adhesive layer 33 is generated. In Example A (see FIG. 16(d)), the peeling strength is 58.2 N and exfoliation of the rubber sheet 38 from the adhesive layer 33 shown in FIG. 16(d) is generated.

It is confirmed from the results of Comparative Example B that PPT resin has a good affinity for PET resin but has a poor affinity for EPDM rubber and thus cannot be expected to give adhesivity. It is also presumed from the results of Comparative Example C that PPT resin is fluidized to deteriorate adhesivity. Example A didn't use PPT resin but used only an imide-based adhesive and thus provided a desirable adhesivity.

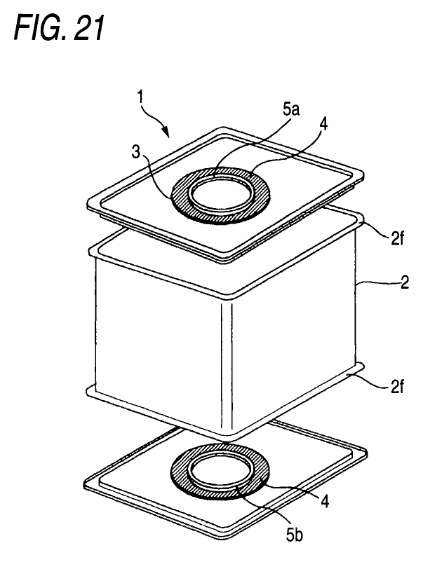

FIG. 21 is a perspective view illustrating an exploded configurational diagram of a battery container of the present invention. In FIG. 21, a lid member 1 obtained by forming a polyester resin-coated aluminum sheet is double-seamed attached to the opening flange 2f of the body 2 of a can. The central portion of the lid member 1 is pierced with a through-hole 3 to which an insulating material 4 made of a polyethylene terephthalate resin for mounting an electrode 5a is attached with an adhesive.

Further, FIG. 21 depicts an embodiment of implementation of provision of opening at both ends of the body 2 of a can wherein the lower lid, too, has an electrode 5b and an insulating material 4 provided thereon.

### (Lid Member for Use in Battery Container)

Firstly, the lid member for battery container to which the insulating material of the present invention is attached will be described. The lid member includes an aluminum sheet as a base, a surface treatment layer and a resin film.

### (Aluminum Sheet)

Examples of the aluminum sheet as a base for lid member include various aluminum materials such as alloys on the order of #3000, #5000 and #6000 as described in JIS4000, and particularly preferred among these alloys are those on the order of #3000.

The thickness of the aluminum sheet is normally preferably from 0.1 to 1.0 mm from the standpoint of strength and formability.

### (Surface Treatment Layer)

The aluminum sheet is preferably subjected to surface treatment on the surface thereof to enhance its workability/adhesivity to the coat resin. Such surface treatment can be carried out by cold-rolling the aluminum sheet, and then subjecting the aluminum sheet thus cold-rolled to treatment with chromium phosphate or other organic or inorganic materials by dipping or spraying. Alternatively, coating type surface treatment may be employed.

In the case where a processed film is formed by subjecting the aluminum sheet to treatment with phosphochromic acids the amount of chromium is preferably from 5 to 40 mg/m², more preferably from 15 to 30 mg/m² in total from the standpoint of workability/adhesivity of the resin film to be laminated.

In the case where no surface treatment such as treatment with phosphochromic acid is effected, the adhesivity of the resin film thus processed is deteriorated, occasionally causing exfoliation after formation/cleaning. Also in the case where the total amount of chromium, including metals and oxides, is less than 5 mg/m², the workability/adhesivity of the resin film is deteriorated, occasionally causing exfoliation to disadvantage. Further, in the case where the total amount of chromium exceeds 40 mg/m², it is disadvantageous from the economical standpoint of view, from the standpoint of deterioration of adhesivity due to the occurrence of cohesive failure or like standpoints.

On the other hand, in the case where the aluminum sheet is subjected to treatment with phosphochromic acid on the side thereof which is not laminated with the resin film, the total amount of chromium is 8 mg/m² or less.

When the total amount of chromium on the outer surface exceeds 8 mg/m², color unevenness can occur or metallic luster tone can be lost. This is because metallic luster is important as external appearance of can.

By way of an example of the method for forming the surface treatment layer, the formation of the phosphochromic acid treatment layer is carried out by a method known per se, e.g., chemical treatment which includes subjecting an aluminum sheet to some etching with caustic soda and degreased cotton, and then dipping the aluminum sheet in a treatment including CrO₃: 4 g/L, H₃PO₄: 12 g/L, F: 0.65 g/L and the balance of water.

### (Laminate Resin Film)

The lid member of the present invention has a resin film formed on a surface-treated aluminum sheet. As the resin film there may be exemplified a polyester film and as the polyester film there is preferably used a biaxially-stretched film of a copolymerized polyethylene terephthalate having a melting point of from 210° C. to 252° C. including an ethylene terephthalate unit as a main component and a small amount of other ester units. This resin film is produced by subjecting a copolymerized polyester including an ethylene terephthalate unit as a main component to T-die method or inflation film-forming method to form a film which is then successively or simultaneously biaxially stretched at the stretching temperature and thermally fixed, and then laminated on the aluminum sheet.

In the polyethylene terephthalate film to be preferably used as the polyester film of the present invention, 70 mol-% or more, particularly 75 mol-% or more of the dibasic acid components in the copolymerized polyester preferably includes terephthalic acid components, 70 mol-% or more, particularly 75 mol-% or more of the diol components in the copolymerized polyester preferably includes ethylene glycol, and from 1 to 30 mol-%, particularly from 5 to 25 mol-% of the dibasic acid components and/or diol components in the copolymerized polyester preferably includes dibasic acid components other than terephthalic acid and/or diol components other than ethylene glycol.

Examples of the dibasic acids other than terephthalic acid include one or a combination of two or more of aromatic dicarboxylic acids such as isophthalic acid, phthalic acid and naphthalenedicarboxylic acid; alicyclic dicarboxylic acids such as cyclohexanedicarboxylic acid; and aliphatic dicarboxylic acids such as succinic acid, adipic acid, sebasic acid and dodecanedioic acid, and examples of the diol components other than ethylene glycol include one or a combination of two or more of propylene glycol, 1,4-butanediol, diethylene glycol, 1,6-hexylene glycol, cyclohexanedimethanol, ethylene oxide adduct of bisphenol A, etc.

Referring to these comonomer combinations, the melting point of the copolymerized polyester must fall within the aforementioned range.

The copolyester to be used should have a molecular weight great enough to form a film and, to this end, those having an intrinsic viscosity (I.V.) of from 0.55 to 1.9 dl/g, particularly from 0.65 to 1.4 dl/g are desirable.

It is important that the copolyester film be biaxially stretched. The degree of biaxial stretching can be confirmed also by fluorescence polarization, birefringence, density gradient column method or the like.

### (Film Thickness)

The thickness of the polyester film is preferably from 8 to 50 μm, particularly preferably from 12 to 40 μm from the standpoint of barrier properties and workability with respect to corrosive components. This biaxially-stretched polyester film may include film compounds known per se, e.g., anti-blocking agent such as amorphous silica, pigment such as carbon black (black), various antistatic agents and lubricant incorporated therein according to known formulations.

### (Laminate)

For lamination, the film to be laminated is allowed to pass through the crystallization temperature zone in as short a period of time as possible, preferably 10 seconds or less, particularly 5 seconds or less. To this end, only the aluminum material is heated before lamination, laminated with a film, and the resin-coated aluminum sheet is then immediately subjected to forced cooling. Cooling is carried out by direct contact with cold air or cold water or pressure contact with forcedly cooled roller. By heating the film to a temperature close to the melting point before lamination, laminating the film on the aluminum sheet, and then rapidly cooling the film, the degree of crystalline orientation can be relaxed.

### (Adhesive Primer)

An adhesive primer may be provided interposed between the polyester film and the aluminum sheet and the adhesive primer preferably exhibits adhesivity to both the aluminum sheet and the film. Representative examples of the primer excellent in adhesivity and corrosion resistance include phenol-epoxy-based primers including a resol type phenolaldehyde resin derived from various phenols and formaldehyde and a bisphenol type epoxy resin, particularly including a phenol resin and an epoxy resin at a weight ratio of from 50:50 to 5:95, particularly from 40:60 to 10:90. The adhesive layer is normally preferably provided to a thickness of from 0.3 to 5 μm.

### (Manufacture of Resin-Coated Aluminum Sheet)

A method for manufacturing the resin-coated aluminum sheet will be described hereinafter. The lamination of the resin film on the aluminum sheet is carried out by contact-bonding the biaxially-stretched polyester and the aluminum sheet under the conditions that the film is melted only at the surface layer in contact with the aluminum sheet. For example, the aluminum sheet is heated to a temperature of not lower than the melting point of the biaxially-stretched polyester film, and then laminated with the film, and the resin-coated aluminum sheet is then immediately rapidly cooled.

Alternatively, the biaxially-stretched polyester film and the aluminum sheet may be contact-bonded with an adhesive primer layer provided on either one of the two components so that they are laminated.

### (Manufacture of Lid Member)

The lid member is produced in the following manner. Firstly, the resin-coated aluminum sheet is stamped to a rectangular sheet by a press to form a desired lid shape which is then formed by a mold to form a concave portion and a through-hole at the central part thereof, thereby producing a lid member.

### (Insulating Material)

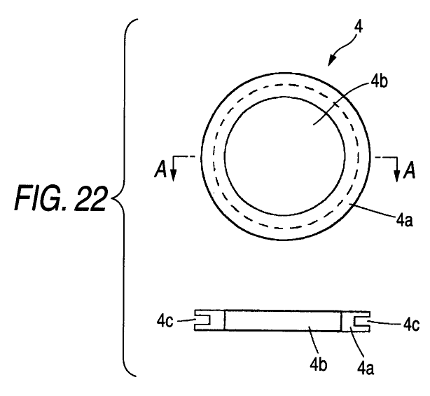

FIG. 22 depicts a plan view (FIG. 22(a)) of an insulating material of the present invention and a sectional view (FIG. 22(b)) taken on line A-A of FIG. 22(a). The insulating material 4 of the present invention has a donut-shaped ring 4a, a bore 4b extending in the thickness direction for mounting an electrode 5a and an annular concave 4c for inserting the inner edge of a through-hole 3 provided in the lid member. In the present embodiment, the annular concave 4c is in the form of a groove provided facing outward radially along the inner diameter at the portion which is substantially central in the thickness direction of the inner diameter of the ring 4a.

Further, the material of the insulating material of the present invention includes a polyethylene terephthalate resin. The reason is that there is obtained a result that the polyethylene terephthalate resin is excellent in corrosion resistance to the electrolyte including as a main component a highly corrosive propylene carbonate salt contained as a battery content. Table 1 shows results of the examination of the corrosion resistance of the insulating material of the present invention.

Further, as the material of the insulating material there may be used a polybutylene terephthalate resin, singly or in admixture with the polyethylene terephthalate resin, besides the polyethylene terephthalate resin.

TABLE 1

| | Dipping time | |
|---|---|---|
| | 100 hours | 500 hours |
| Insulating material of | No corrosion observed | No corrosion observed |
| the present invention | | |
| (polyethylene | | |
| terephthalate) | | |
| Reference insulating | No corrosion observed | No corrosion observed |
| material (polybutylene | | |
| terephthalate) | | |

### (Evaluation of Corrosion Resistance to Electrolyte Including a Propylene Carbonate Salt as a Main Component)

The results of 800 hour dipping is the same as that of 500 hour dipping.

The thickness of the insulating material of the present invention is not specifically limited so far as it is greater than the thickness of the lid member material but is preferably from 0.3 to 3.0 mm. The outer diameter or inner diameter of the ring 4a is determined by the size of the lid member material or the electrode and thus is not specifically limited in the present invention.

### (Method for Manufacturing Insulating Material)

A lid member which is previously pierced with a through-hole is mounted in a mold wherein a molten polyethylene terephthalate resin is then formed in the through-hole formed in the lid member so that the polyethylene terephthalate resin is integrally attached thereto.

### (Adhesive)

In the present invention, an adhesive made of at least one hardener selected from the following (A) polyester resin+(B) phenolic resin, amino resin and polyisocyanate resin is spread over at least one side of the lid member to enhance the adhesivity of the lid member having a polyester resin provided on the surface thereof to the insulating material.

### (A) Polyester Resin

As the polyester resin in the adhesive to be used in the present invention there is essentially used a polyester resin having a number-average molecular weight of from 8,000 to 30,000 including as dicarboxylic acid components from 80 to 100 mol-% of terephthalic acid and from 0 to 20 mol-% of dicarboxylic acids other than terephthalic acid and as glycol components from 60 to 90 mol-% of propylene glycol and from 10 to 40 mol-% of glycols other than propylene glycol.

When the content of terephthalic acid as dicarboxylic acid component falls below the aforementioned range, adhesive properties such as flexibility and whitening resistance are deteriorated.

Further, when the content of propylene glycol as glycol component falls below the aforementioned range, the solvent dissolution resistance is deteriorated and, on the other hand, when the content of propylene glycol exceeds the aforementioned range, adhesive properties such as workability are deteriorated.

Examples of the carboxylic acid components other than terephthalic acid include isophthalic acid, naphthalenedicarboxylic acid, p-β-oxyethoxybenzoic acid, biphenyl-4,4′-dicarboxylic acid, diphenoxyethane-4,4′-dicarboxylic acid, 5-sulfosodium isophthalic acid, hexahydroterephthalic acid, adipic acid, sebasic acid, trimellitic acid, pyromellitic acid, etc., but an aromatic dicarboxylic acid is preferred to aliphatic carboxylic acid from the standpoint of elution resistance.

On the other hand, examples of the alcohol components other than propylene glycol include alcohol components such as 1,4-butanediol, ethylene glycol, neopentyl alcohol, 1,6-hexylene glycol, diethylene glycol, triethylene glycol, cyclohexane dimethanol, ethylene oxide adduct of bisphenol A, glycerol, trimethylolpropane, pentaerythritol, dipentaerythritol and sorbitan.

The polyester resin preferably has a glass transition point (Tg) of 30° C. or more, particularly from 50 to 110° C. When the glass transition point (Tg) is lower than the aforementioned range, the moist heat resistance can be deteriorated and the barrier properties with respect to corrosive components can be deteriorated.

Further, as previously mentioned, the number-average molecular weight preferably falls within the range of from 8,000 to 30,000, particularly from 10,000 to 20,000.

When the number-average molecular weight is smaller than the aforementioned range, the adhesivity, moist heat resistance, workability, etc. are deteriorated as compared with the case where the number-average molecular weight falls within the aforementioned range, and, on the other hand, when the number-average molecular weight is greater than the aforementioned range, the polyester resin has a remarkably raised viscosity as adhesive and a deteriorated workability as compared with the case where the number-average molecular weight falls within the aforementioned range. The polyester resin is produced by an ordinary high molecular polyester manufacturing method involving ester hardening method or direct esterification method.]

### (B) Hardener

### (Hardener for Use in Adhesive)

The phenolic resin to be used as a hardener is a resin derived from phenols and formaldehyde or functional derivatives thereof, and in the present invention, as the phenols there are preferably used phenols mainly including carbolic acid and/or meta-cresol, particularly preferably resol type phenolic resin. The phenols other than carbolic acid and meta-cresol are not specifically limited, but monocyclic monovalent phenols are preferably used, and examples of these monocyclic monovalent phenols include trifunctional phenols such as m-ethylphenol, 3,5-cresol and m-methoxyphenol, bifunctional phenols such as o-cresol, p-cresol, p-tert-butylphenol, p-ethylphenol, 2,3-xylenol, 2,5-xylenol, p-tert-amylphenol, p-nonyl phenyl, p-phenylphenol and p-cyclohexylphenol, and monofunctional phenols such as 2,4-xylenol and 2,6-xylenol.

As the amino resin to be used as a hardener there is particularly exemplified a benzoguanamine resin or melamine resin, and these amino resins may be used singly or the benzoguanamine resin and the melamine resin may be used in blend. Further, the amino resin has a basic nitrogen atom concentration of from 5 to 20 gram atoms, particularly from 8 to 17 gram atoms per 100 g of resin and a methylol group and etherified methylol group concentration of from 0.5 to 1.9 mols, particularly from 0.7 to 1.7 mmols per 100 g of resin to advantage.

As the polyisocyanate resin hardener there may be used the following polyisocyanate. Examples of the polyisocyanate employable herein include diisocyanates such as aromatic diisocyanate, e.g., 2,4-tolylene diisocyanate, 2,6-tolylenediisocyanate, xylene-1,4-diisocyanate, xylene-1,3-diisocyanate, 4,4′-diphenylmethanediisocyanate, 2,4′-diphenylmethane diisocyanate, 4,4′-diphenyletherdiisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropanediisocyanate, phenylenediisocyanate, p-phenylenediisocyanate, naphthylene-1,4-diisocyanate, naphthylene-1,5-diisocyanate, 3,3′-dimethoxydiphenyl-4,4′-diisocyanate, aromatic polyisocyanate, e.g., polyphenylene, polymethylene polyisocyanate, crude tolylenediisocyanate, aliphatic diisocyanate, e.g., tetramethylene diisocyanate, hexamethylene diisocyanate (HDI), decamethylene diisocyanate, lysine diisocyanate and alicyclic diisocyanate, e.g., isophorone diisocyanate (IPDI), hydrogenated tolylene diisocyanate, hydrogenated xylene diisocyanate, hydrogenated diphenylmethane diisocyanate, tetramethylxylene diisocyanate, biureted form of the aforementioned isocyanates, urethodione modification product of the aforementioned isocyanates, carbodiimide modification product of the aforementioned isocyanates, isocyanurate modification product of the aforementioned isocyanates, urethoneimine modification product of the aforementioned isocyanates, adduct of the aforementioned isocyanates with polyol, and mixed modification products thereof.

Further, these polyisocyanates may be used in the form of urethane precursor such as prepolymer, modification product, derivative and mixture with active hydrogen-containing compound such as polyol and polyamine.

Preferred hardeners are aliphatic and/or alicyclic isocyanates, and particularly preferred among them are trimer (isocyanurated form) hexamethylene diisocyanate (HDI) and isophorone diisocyanate (IPDI).

In the present invention, the terminal NCO group of the isocyanate hardener component is preferably blocked. Examples of the blocking agent include phenolic compounds such as phenol, cresol, ethyl phenol and butyl phenol, alcohol-based compounds such as 2-hydroxypyridine, butyl cellosolve, propylene glycol monomethyl ether, benzyl alcohol, methanol, ethanol, n-butanol, isobutanol and 2-ethylhexanol, active methylene-based compounds such as dimethyl malonate, diethyl malonate, methyl acetoacetate, ethyl acetoacetate and acetyl acetone, mercaptan-based compounds such as butyl mercaptane and dodecyl mercaptan, lactam-based compounds such as ε-caprolactam, δ-valerolactam and γ-butyrolactam, imidazole-based compounds such as imidazole and 2-methylimidazole, urea-based compounds such as urea, thiourea and ethyleneurea, oxime-based compounds such as formamide oxime, acetaldoxime, acetone oxime, methyl ethyl ketoxime and cyclohexanone oxime, and amine-based compounds such as diphenylaniline, aniline, carbazole, ethyleneimine and polyethyleneimine. They may be used singly or in admixture of two or more thereof. Among them, methyl ethyl ketone oxime can be preferably used.

The reaction of such a blocking agent with the isocyanate hardener component can be carried out, e.g., at from 20° C. to 200° C. in the presence of a known inactive solvent or catalyst as necessary. The blocking agent is preferably used in an amount of from 0.7 to 1.5 mols per mol of terminal isocyanate group.

### (Mixing Proportion)

As the adhesive to be used in the present invention there is preferably used one including a polyester resin (A) and a hardener (B) at a mixing ratio (A:B) of from 90:10 to 99:1. In the case where the hardener component (B) is less than the aforementioned range, an adhesive excellent in corrosion resistance, etc. cannot be formed, and in the case where the hardener component (B) is greater than the aforementioned range, an adhesive excellent in adhesivity, workability, etc. cannot be formed.

The adhesive to be used in the present invention preferably includes a solvent incorporated therein in an amount of from 150 to 550 parts by weight based on 100 parts by weight of resin component. When the amount of the solvent is less than the aforementioned range, the adhesive exhibits deteriorated bond working properties or can difficultly form an adhesive layer excellent in adhesivity or corrosion resistance. On the other hand, when the amount of the solvent is greater than the aforementioned range, the adhesive can difficultly form an adhesive layer having a sufficient thickness and requires a large amount of a solvent to disadvantage from the economical standpoint of view.

As the solvent there may be used any solvent known per se so far as it can dissolve the aforementioned resin component therein. The following compounds are preferably used, but the present invention is, of course, not limited thereto.

Solvents such as isopropyl alcohol (IPA), isobutyl acetate, n-butanol, ethylene glycol monoisopropyl ether (GIP), methoxypropyl acetate, cyclohexanone, Solvesso 100, DBE (basic acid ester), diethylene glycol monobutyl ether (BDG) and butyl diglycol acetate may be used, and many of those having different melting points are used in admixture.

The adhesive to be used in the present invention may be spread over the resin-coated aluminum sheet or formed lid member by an arbitrary means such as spray coating, brush coating, dip coating and roller coating. The thickness of the spread can be predetermined to fall within the range of from 1 μm to 20 μm, particularly from 3 μm to 15 μm as calculated in terms of dried material. The baking conditions after spreading can normally be properly selected from temperature of from 150° C. to 300° C. and baking time of from 0.2 minutes to 30 minutes.

The adhesive of the present invention will be described in detail in the following examples and comparative examples.

### [Manufacture of Polyester Resin]

Into a stainless autoclave equipped with an agitator, a thermometer and a partial reflux condenser are properly charged polybasic acids, polybasic acid esters and polyvalent alcohols as raw materials and a catalyst which are then heated to a reaction temperature of from 210° C. to 250° C. where they are then adjusted under a pressure of 2 mmHg or less for 3 to 6 hours to synthesize various polyester resins. The resin composition, the number-average molecular weight (Mn) and the glass transition temperature (Tg) of the polyester resin thus obtained are set forth in Table 2. The composition of the polyester resin is determined by NMR (nuclear magnetic resonance). The number-average molecular weight (Mn) of the polyester resin is determined by GPC (gel permeation chromatography). As the developing solvent to be used herein there is used chloroform, and Mn in styrene equivalence is determined from the calibration curve with styrene as reference sample. The glass transition temperature (Tg) of the polyester resin is determined by differential scanning calorimetry (DSC). Referring to the measurement conditions, the temperature rising rate is 10° C./min and the measuring temperature range is from 20° C. to 300° C.

### [Adhesivity Test]

The lid member which has an insulating material mounted thereon by an insert injection method is fixed to a checking fixture for fixing the curled portion of the lid member thereto to form a sealed portion. By feeding air into the sealed portion, the air pressure is gradually raised from 0.1 MPa. The air pressure developed when the expansion deformation of the lid member proceeds so far as to no longer maintain the adhesion between the insulating material and the lid member and cause air leakage is confirmed. When no air leakage occurs even if the air pressure is raised to a predetermined value, it is then judged that the adhesivity is good.

### Example 6

A polyester resin having a number-average molecular weight (Mn) of 13,000 and Tg of 61° C. including 100 mol-% of terephthalic acid as a dicarboxylic acid component, 60 mol-% of propylene glycol and 30 mol-% of ethylene glycol as glycol component, 10 mol-% of CHDM (cyclohexanedimethanol) and 0.2 mol-% (based on glycol component) of trimethylolpropane is dissolved in a 1/1/1 mixture of cyclohexanone, Solvesso-100 and methoxypropyl acetate, IPDI (isophorone diisocyanate) trimer (isocyanurated form) blocked by MEK oxime and titanium oxide are added to the solution, and the mixture is then thoroughly stirred to prepare a polyester resin.

The mixing proportion of polyester resin and blocked IPDI trimer is 90:10, and titanium oxide is incorporated in an amount of 40 parts by weight based on resin content. The coating compound thus obtained had a solid content of 42% by weight and #4 Ford Cup viscosity of 63 seconds.

The aforementioned polyester resin is spread over a polyester resin-coated aluminum sheet having a thickness of 0.50 mm, and then backed at 200° C. for 8 minutes. Thereafter, the resin-coated aluminum sheet is stamped to a rectangular sheet by a press to form a desired lid shape which is then formed by a mold to form a concave portion and a through-hole at the central part thereof, thereby producing a lid member. Then, the lid member is mounted in a mold wherein a molten polyethylene terephthalate resin is then formed in the through-hole formed in the lid member so that the polyethylene terephthalate resin is integrally attached thereto.

The results of Example 6 are set forth in Table 2 together with polyester composition and hardener resin.

### Examples 7 to 12

In the same manner as in Example 6, insulating materials are bonded to the lid member with the adhesives of Examples 7 to 12 the formulation of which are set forth in detail in Table 2, and evaluation is then effected. In Example 10, HDI (hexamethylene diisocyanate) trimer (isocyanurated form) blocked by MEK oxime is used as a hardener.

Examples 11 and 12 are examples in which other hardeners are used instead of polyisocyanate hardener. In Example 11, an m-cresol-phenol resin having Mn of 700 and Mw (weight-average molecular weight) of 1,350 is used as a hardener. The added number of formaldehydes is 2.5 per phenol nucleus and as methylol group there is used a fully butyletherified methylol group.

In Example 12, a mixture of a benzoguanamine resin (Mycoat 106, produced by Mitsui Cytec Co., Ltd.) and a melamine resin (Cymel 325, produced by Mitsui Cytec Co., Ltd.) the formulation of which are set forth in Table 2 is used as a hardener.

The results are set forth in detail in Table 2. The insulating materials including the adhesives of Examples 6 to 12 gave good results of adhesivity.

### Comparative Example 1

In the same manner as in Example 6, the lid member is bonded to insulating material with an adhesive of Comparative Example 1 the formulation of which is set forth in detail in Table 2 and then evaluated for adhesivity. In Comparative Example 1, the same polyester resin as used in Example 6 is used, but the harder (B) of the present invention is not used, resulting in the deterioration of adhesivity.

TABLE 2

| | | | | | | | | Comparative |
|---|---|---|---|---|---|---|---|---|
| | Example 6 | Example 7 | Example 8 | Example 9 | Example 10 | Example 11 | Example 12 | Example 1 |
| Terephthalic acid | 100 | 100 | 90 | 80 | 100 | 100 | 100 | 100 |
| (mol-%) | | | | | | | | |
| Ethylene glycol | 30 | 30 | 25 | 30 | 25 | 25 | 30 | |
| (mol-%) | | | | | | | | |
| Propylene glycol | 60 | 75 | 75 | 90 | 60 | 75 | 75 | 60 |
| (mol-%) | | | | | | | | |
| Number-average | 13,000 | 18,000 | 15,000 | 18,000 | 13,000 | 18,000 | 18,000 | 13,000 |
| molecular weight | | | | | | | | |
| (Mn) | | | | | | | | |
| Tg (° C.) | 61 | 82 | 75 | 57 | 61 | 82 | 82 | 61 |
| Hardener resin | Poly- | Poly- | Poly- | Poly- | Poly- | Phenol | Amino | — |
| | isocyanate | isocyanate | isocyanate | isocyanate | isocyanate | | | |
| Adhesivity | Good | Good | Good | Good | Good | Good | Good | Poor |

The kind of the storage battery of the present invention doesn't matter so far as it is a chargeable electrical product such as secondary battery, electrolytic capacitor and capacitor.

While the present invention is described in detail and with reference to specific embodiments thereof, it will be apparent to one skilled in the art that various changes and modifications can be made therein without departing from the spirit and scope thereof.

The present application is based on Japanese Patent Application (JP-A-2005-144725) filed on May 17, 2005, Japanese Patent Application (JP-A-2005-144741) filed on May 17, 2005, Japanese Patent Application (JP-A-2005-144413) filed on May 17, 2005, and Japanese Patent Application (JP-A-2005-144427) filed on May 17, 2005, and its contents are hereby incorporated by reference.

### INDUSTRIAL APPLICABILITY

The present invention is suitable for storage battery including an electrode rod protruding beyond its lid body.

In accordance with the present invention, an insulating material made of a polyethylene terephthalate resin is used, the battery content has an excellent corrosion resistance to the electrolyte including a highly corrosive propylene carbonate salt as a main component, etc. and an enhanced leakage resistance.

Further, the battery container of the present invention includes an insulating material made of a polyethylene terephthalate resin and has the insulating material bonded to a lid member made of a polyester resin-coated aluminum sheet with an adhesive having a specific formulation, whereby the insulating material can be firmly bonded to the through-hole in the lid member, making it possible to provide an excellent resistance to leakage of battery content.

1. A storage battery comprising:
a lid body having a hole formed therein,
an annular member provided surrounding the hole,
a current collecting plate disposed on one side of the lid body,
an electrode rod extending from the current collecting plate and protruding beyond the hole and a pressing plate disposed on the other side of the lid body, so as to interpose the annular member between the pressing plate and the current collecting plate to fix the electrode rod to the lid body, wherein
a collar portion is provided at the base of the electrode rod, the collar portion having a greater diameter than that of the electrode rod and a greater thickness than that of the lid body, and being arranged to receive the pressing plate, and
the annular member is entirely or partially formed by a rubber sheet having a greater thickness than that of the collar portion.

2. A storage battery comprising:
a lid body having a hole formed therein,
an annular member provided surrounding the hole,
a current collecting plate disposed on one side of the lid body,
an electrode rod extending from the current collecting plate and protruding beyond the hole, and
a pressing plate disposed on the other side of the lid body, so as to interpose the annular member between the pressing plate and the current collecting plate to fix the electrode rod to the lid body, wherein
the annular member is formed by a resin sheet of which forward end has a slant provided thereon for pressing against an O-ring or liquid packing set at the base of the electrode rod.

3. A storage battery comprising:
an electricity-storing element and a current collecting plate received in a cylinder body, an opening of the cylinder body being closed by a lid body having an electrode rod through-hole of which edge is surrounded by an annular member made of a resin, and
a disc sealing member provided interposed between the current collecting plate and the annular member made of a resin, wherein
the lid body and the current collecting plate are disposed parallel to each other to keep the electrode piercing portion airtight,
the disc sealing member has a three-layer structure having a PET film laminated on the upper and lower sides of a rubber sheet, and
one of the two PET films is arranged to be heat-fused to the metallic current collecting plate, and the other is arranged to be heat-fused to the annular member made of a resin to exert an airtighting effect.

4. A method for manufacturing a lid body for storage battery including:
a resin-coated metallic sheet having a PET film laminated on a metallic sheet, and
an annular member made of a rubber integrally attached thereto surrounding a hole provided therein, the annular member made of a rubber keeping the airtightness of an electrode rod piercing portion,
the method comprising:
a step of forming a hole in the resin-coated metallic sheet,
a step of spreading an imide-based adhesive over the PET film surrounding the hole and drying the adhesive to form an adhesive layer,
a step of setting the resin-coated metallic sheet including an adhesive layer into a forming mold,
a step of extruding a rubber-based melt material into the forming mold to form an annular member made of a rubber, and
a step of removing the forming mold to obtain a lid body.

5. An insulating material for electrode mounting to be used in a battery container, which is made of a polyethylene terephthalate resin.

6. A battery container comprising:
a lid member obtained by forming a polyester resin-coated aluminum sheet double-seamed attached to an opening of a body of a can, and
a polyethylene terephthalate resin insulating material for electrode mounting, the polyethylene terephthalate resin insulating material being attached to a through-hole provided by piercing a central part of the lid member with an adhesive, wherein
the adhesive is obtained by incorporating a hardener (B) in a resin (A) as follows:
(A) a polyester resin comprising a dicarboxylic acid component mainly including terephthalic acid and a glycol component, and having a glass transition temperature of from 30° C. to 110° C.;
(B) a hardener made of at least one of phenolic resin, amino resin and polyisocyanate resin.

7. A battery container comprising:
a lid member obtained by forming a polyester resin-coated aluminum sheet, the lid member attached double-seamed to an opening of a body of a can, and
a polyethylene terephthalate resin insulating material for electrode mounting, the polyethylene terephthalate resin insulating material being attached to a through-hole provided by piercing a central part of the lid member with an adhesive, wherein
the adhesive is obtained by incorporating a hardener (B) in a resin (A) as follows:
(A) a polyester resin comprising a dicarboxylic acid component having a terephthalic acid content of from 80 to 100 mol-% and a glycol component, having a glass transition temperature of from 30° C. to 110° C. and having a number-average molecular weight of from 8,000 to 30,000;
(B) a hardener made of a polyisocyanate resin.

8. The battery container as described in claim 6, wherein the adhesive has a (A):(B) weight ratio of from 90:10 to 99:1.

9. The battery container as described in claim 7, wherein the adhesive has a (A):(B) weight ratio of from 90:10 to 99:1.
